(19) United States
(12) Patent Application Publication
(10) Pub. No.: US 2014/0020250 A1
(43) Pub. Date: Jan. 23, 2014

(54) FRICTION TORQUE BARCODE

(71) Applicant: Schaeffler Technologies AG & Co. KG, Herzogenaurach (DE)

(72) Inventors: Chad LABELLE, TROY, MI (US); Shakeel SHAIKH, WINDSOR (CA); Michael CLAASSEN, BRUCE TOWNSHIP, MI (US)

(21) Appl. No.: 13/944,075

(22) Filed: Jul. 17, 2013

Related U.S. Application Data
(60) Provisional application No. 61/672,490, filed on Jul. 17, 2012.

(51) Int. Cl. F16C 43/04

(52) U.S. Cl. CPC F16C 43/04
USPC 29/898.09; 264/400; 427/256

(57) ABSTRACT

A method to ascertain measured friction torque to a bearing and a method to reduce preload variation of a hearing pair or set. Friction torque of a bearing is measured at a known load and speed. The value of the measured friction torque is then printed in a data matrix that is then applied to the bearing that was measured. Prior to assembling the bearings on a shaft system, the data matrix is read. The targeted friction torque is calculated for the shaft system based on the desired assembly preload. The bearing preload is then set and verified by measuring the friction torque of the pair of bearings assembled on the shaft. As a result of the method, bearing friction torque variation is substantially mitigated.

### FIELD OF INVENTION

The present invention relates to bearings and more particularly to the measurement of friction torque of a bearing, which is printed in a data matrix that is affixed to the bearing.

### BACKGROUND OF THE INVENTION

Shafts, such as pinion shafts, are typically supported by two bearings in an “X-arrangement” or an “O-arrangement.” The bearing pair is normally preloaded axially. In order to ensure that the desired preload (force) is achieved, friction torque is measured at a given speed, and a specific friction torque value is targeted. The friction torque corresponds to an axial load range on the bearings. The friction torque to axial load relationship is specific to a given hearing design and has a tolerance. The relationship can be developed empirically or analytically. Also, the tolerance range of the friction torque for the bearings at the targeted preload contributes to preload variation.

U.S. Patent Publication No. 2011/0219886, for example, teaches a process for measuring preload of low-rolling resistance bearings. Here, bearings are mounted on a pinion shaft and the preload of the bearing is then set by applying an axial compressive force against the bearings while the shaft is rotated. Here, friction torque is not used to measure preload.

U.S. Pat. No. 6,868,609, for example, teaches a method and an apparatus for preloading pinion bearings. Here, the bearings are also mounted on a shaft prior to being preloaded with a “shim member,” or spacer, that is disposed between the shaft and the bearings. Preload is determined by taking various measurements and applying a predetermined preload to the hearings.

U.S. Pat. No. 6,000,134, for example, teaches a method for preloading antifriction bearings after the bearings are rotatably on a shaft, and U.S. Pat. No. 6,736,544, which also discloses a method for preloading bearings after the bearings are rotatably mounted on a shaft

### SUMMARY OF THE INVENTION

The present invention is directed to a method of measuring bearing preload to reduce the impact of a tolerance range of preload in a bearing set. The present invention thus measures friction torque of a hearing at a given load and speed. The value of the measured friction torque is then printed (i.e., laser marked) into a data matrix that is then applied to the bearing that was measured. Prior to assembly of a shaft system, the data matrix, or barcode, of the bearing is read using a camera. The targeted friction torque is calculated for the shaft system based on the desired assembly preload. The resulting preload has a reduced variation because the bearing friction torque variation is substantially mitigated.

The present invention reduces the impact of the tolerance range on the preload variation in a bearing set. For example, a typical pinion bearing set can have a friction torque tolerance of ±7 Ncm at 5 kN preload and 50 rpm and the shaft system assembly equipment can also have a friction torque setting tolerance in the range of ±10 Ncm. The resulting preload range for a typical tandem ball bearing pinion set would be approximately 3.1 kN. However, if the friction torque of the bearing set is known by reading the measured value from a data matrix as taught herein, then the bearing set friction torque tolerance can effectively be reduced to zero. The resulting preload range for a typical tandem hall bearing pinion set can then be reduced to approximately 1.3 kN (58% reduction).

Broadly, the present invention can be defined as a method of ascertaining measured friction torque to a bearing. Here, friction torque of the bearing is measured at a known load and a known speed. The friction torque measured is entered in a data matrix. The data matrix is then applied on the bearing by printing, laser marking, or etching.

The data matrix can be applied to an end side of an outer bearing ring or an inner bearing ring of the bearing. Also, the data matrix can be, for example, a barcode. Moreover, the data matrix can contain additional information, such as the date code or a part number.

The present invention can also be defined as a method of reducing preload variation of a bearing. Here, friction torque of the bearing is measured at a known load and a known speed. The friction torque that is measured is entered in a data matrix. The data matrix is applied on the bearing by printing, laser marking, or etching. The data matrix is then read with a reading device, such as camera or another appropriate device. The bearing pair is then installed on a shaft where the targeted friction torque is calculated based on a desired preload. The preload of the bearing is set and verified by measuring the friction torque of the bearing pair installed on the shaft.

### BRIEF DESCRIPTION OF THE DRAWINGS

The present invention will be further understood and appreciated by reading the following description in conjunction with the accompanying drawing, in which:

FIG. 1 illustrates a cross-sectional view of a bearing on which a data matrix is applied;

FIG. 2 illustrates a partial view of a bearing on which a data matrix is applied;

FIGS. 3a, 3b, and 3c illustrate various data matrices that can be used in conjunction with a bearing; and

FIG. 4 is a flow chart that outlines the method of the present invention.

### DETAILED DESCRIPTION OF THE INVENTION

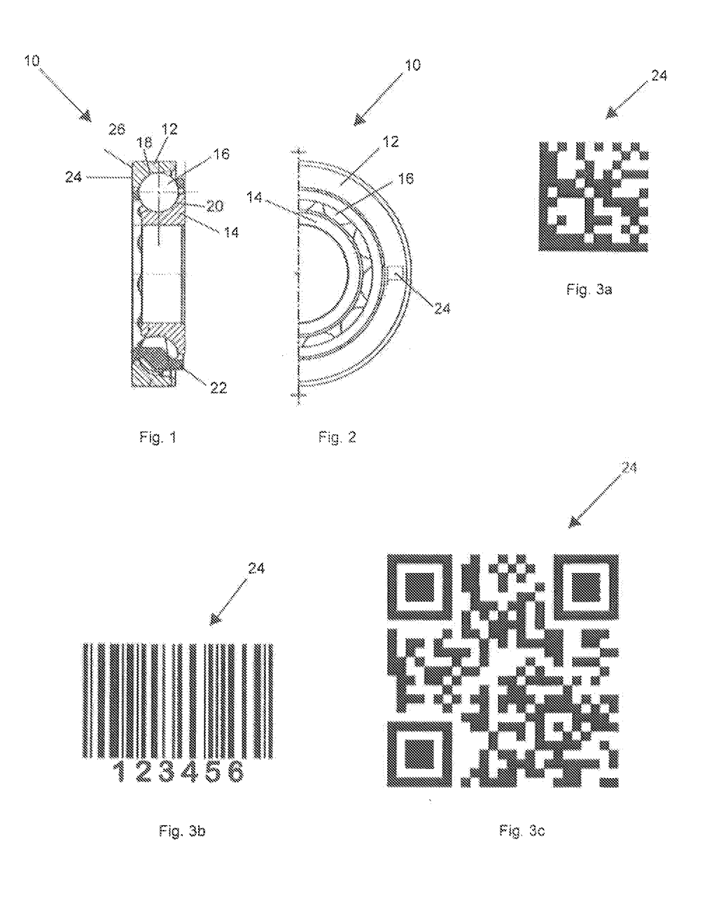

Referring now to the drawings, FIG. 1 shows a cross-sectional view of an angular contact ball bearing 10. The hearing 10 has an outer ring 12, an inner ring 14 and rolling elements 16 arranged between the outer ring 12 and the inner ring 14. The rolling elements 16 roll on raceways 18, 20 formed in the outer ring 12 and the inner ring 14 and are secured by a cage 22.

A data matrix, or barcode, 24 (e.g., 2 dimensional data matrix) that contains measured friction torque is applied on an end side 26 of the outer ring 12 of the bearing 10. Alternatively, the data matrix 24 can be applied on an end side of the inner ring 14 of the bearing 10 or any other side or surface of the bearing 10. In addition to measured friction torque, the data matrix 24 may also contain any other relevant information (e.g., date code, customer part number, etc.). Moreover, the data matrix 24 can be printed as any type of barcode, including, but not limited to a UPC label, a QR code with or without Arabic text or any type of a means of printing data.

FIG. 2 illustrates a partial view of the bearing 10 on which the data matrix 24 is applied.

FIG. 3 shows various data matrices 24 that can be used in conjunction with the bearing 10.

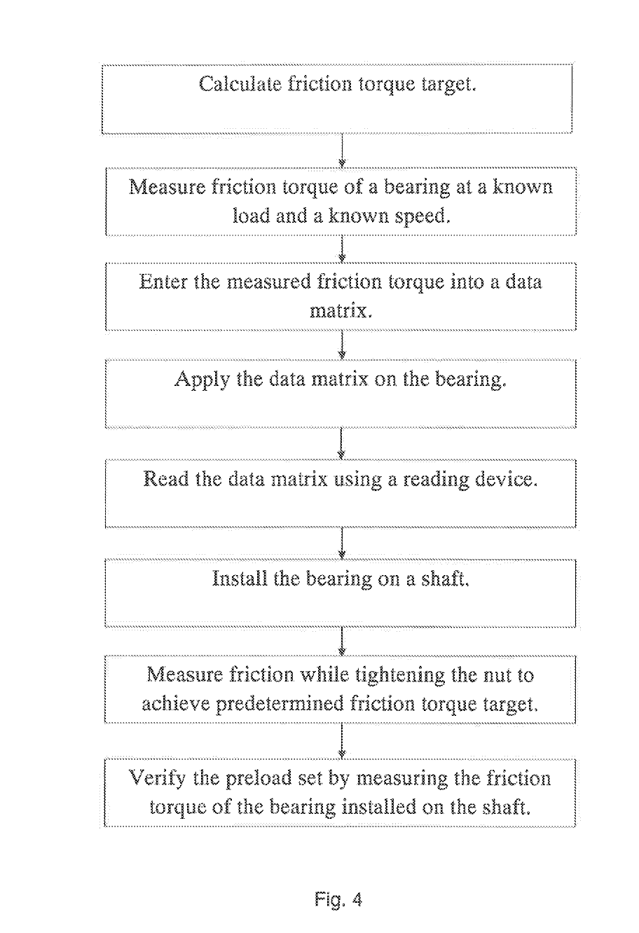

FIG. 4 is a flow chart outlining the steps of the method. As can be seen in FIG. 4, a predetermined friction torque target is calculated based on a desired assembly preload and friction torque of the bearing 10 is measured at a known load and known speed. The measured friction torque is then entered into the data matrix 24. The data matrix 24 is then applied on the bearing 10. After application of the data matrix 24, the data matrix 24 is read by a reading device such as a camera. The bearing 10 is then installed on a shaft. During installation of the bearing 10, friction is measured while tightening the nut to achieve the predetermined friction torque target. The preload of the bearing 10 is then set and verified by measuring the friction torque of the bearing 10.

The present invention has been described with reference to a preferred embodiment. It should be understood that the scope of the present invention is defined by the claims and is not intended to be limited to the specific embodiment disclosed herein.

### REFERENCE NUMERALS

10 Bearing

12 Outer Ring

14 Inner Ring

16 Rolling Elements

18 Raceway

20 Raceway

22 Cage

24 Data Matrix

26 End Side

What is claimed:

1. A method of ascertaining measured friction torque of a bearing, comprising the steps of:
measuring fraction torque of the bearing at a known load and a known speed;
entering the measured friction torque into a data matrix; and
applying the data matrix on the bearing.

2. The method of claim 1, wherein the data matrix is applied on the bearing by printing, laser marking, or etching.

3. The method of claim 1, wherein the data matrix is a barcode.

4. The method of claim 1, wherein the data matrix contains a date code or a part number.

5. The method of claim 1, wherein the data matrix is applied to an end side of an outer hearing ring or an inner hearing ring of the hearing.

6. A method of reducing preload variation of a bearing, the method comprising the steps of:
measuring friction torque of the bearing at a known load and a known speed;
entering the measured friction torque into a data matrix;
applying the data matrix on the bearing;
reading the data matrix with a reading device;
installing the hearing on a shaft;
calculating a targeted friction torque based on a desired preload;
setting the preload of the bearing; and
verifying the preload of the bearing by measuring the friction torque of the bearing installed on the shaft.

7. The method of claim 6, wherein the data matrix is applied on the bearing by printing, laser marking, or etching.

8. The method of claim 6, wherein the data matrix is a barcode.

9. The method of claim 6, wherein the data matrix contains a date code or a part number.

10. The method of claim 6, wherein the data matrix is applied to an end side of an outer bearing ring or an inner bearing ring of the hearing.

11. The method of claim 6, wherein the reading device is a camera.
